(19) United States
(12) Patent Application Publication
(10) Pub. No.: US 2026/0124969 A1
(43) Pub. Date: May 7, 2026

(54) FASTENING SYSTEM FOR CHILD SEATS

(71) Applicant: CYBEX GmbH, Bayreuth (DE)

(72) Inventors: Stoil BOZHIKOV, Bayreuth (DE); Harald KOHLMANN, Bayreuth (DE)

(21) Appl. No.: 19/118,911

(22) PCT Filed: Sep. 29, 2023
(86) PCT No.: PCT/EP2023/077061

§ 371 Date: Apr. 7, 2025

(30) Foreign Application Priority Data
Oct. 7, 2022 (DE) 20 2022 105 670.6

(51) Int. Cl. B60N 2/26; B60N 2/28

(52) U.S. Cl. CPC B60N 2/269; B60N 2/2827; B60N 2/2893

(57) ABSTRACT

A fastening system for fastening a child seat or a base for a child seat to a motor vehicle seat, comprises a hook for engaging around a bracket provided on the motor vehicle, such as an Isofix anchorage, in order to couple the fastening system to the motor vehicle seat. The hook is switchable between a first position, in which it does not couple the fastening system to the motor vehicle seat, and a second position, in which it couples the fastening system to the motor vehicle seat. An electrical detection device comprises a sensor suitable for detecting whether the hook is in the first or the second position, wherein the detection device is configured for indirect detection of the respective position or wherein the detection device, in particular the sensor, has a distance relative to the hook, both in its first and in its second position.

The invention relates to a fastening system for fastening a child seat and/or a base for a child seat to a motor vehicle seat.

A child seat is understood by a person skilled in the art to be a child restraint system for transporting a child in a vehicle, preferably a motor vehicle.

It should be noted that in the context of the present invention, the term “child seat” is to be understood as a generic term for (classic) child seats, infant carriers, booster seats, booster cushions, etc. For example, the child seat of the present invention may be a (classic) child seat (for larger children, e.g. Group I/II and/or III child seat) which has a backrest which is structurally separated from a seat area and whose inclination can be varied relative to the seat area if necessary. The structural boundary can be formed, for example, by a kink or similar. In general, however (unless otherwise stated in the specific context) child seat is always to be understood as an abbreviated form of writing for “child seat, for example infant carrier, booster seat and/or booster cushion” or, in the context of the present invention, features provided for a (classic) child seat are in principle also applicable, for example, to an infant carrier, a booster seat and/or a booster cushion and vice versa (unless otherwise stated). The same applies to the term “child”, which is also to be understood as a generic term for children, babies and infants. So-called “infant carriers” often (only) comprise a one-piece shell for holding the baby or child and may include a separate belt system, possibly a headrest and possibly other components. Instead of a (structurally delimited) backrest, such “infant carriers” have a back section that adjoins a “seat area” in which the child's buttocks can be accommodated.

The term “base for a child seat” is understood by a person skilled in the art to mean, in particular, a base to which a child seat can be detachably or non-detachably fastened.

Child seats, infant carriers, booster seats etc. that can be fastened to a vehicle seat have been known for some time. Such child seats, infant carriers, booster seats etc. serve as seating for children, babies and infants and offer them increased protection, especially in the event of an accident and/or emergency braking. Such child seats can be secured using the car's belt system or by means of an Isofix anchorage. This type of fastening secures the child seat to the car seat in the event of an accident, so that it is held in place on the car seat and not thrown forward, particularly in the event of a rear-end collision (impact) and/or emergency braking.

Since such child seats often have to be changed and/or installed and removed between different vehicles, especially motor vehicles, it is particularly important that the detachable anchorage of a child seat enables user-friendly handling. Furthermore, however, easier handling should not be at the expense of the child's safety in road traffic or in the event of an accident.

The fastening of the child seat to the vehicle seat must therefore be as stable as possible. At the same time, however, it is also desirable if the fastening allows a certain degree of adjustability so that it can be optimally adapted to different car seats.

An adjustable fastening system, in particular a telescopic system, for fastening a child restraint system, in particular a child seat, to a motor vehicle seat is known, for example, from EP 3 600 954B1. However, although the fastening system dis-closed there consists of a large number of different individual parts (as a result of which the design is considered to be in need of improvement in terms of manufacturing costs and susceptibility to faults in use), it lacks a means of detecting the fastening of the child restraint system.

EP 1 871 637 A1 discloses a fastening system for fastening a child restraint system, in particular a child seat, to a motor vehicle seat. The fastening system comprises a first connector for connection to the motor vehicle seat and a second connector for connection to an anchorage of a child seat, wherein the second connector comprises a detector for detecting a secure connection to the motor vehicle seat. However, the reliability of the detection of EP 1 871 637 A1 is considered to be in need of improvement. Another disadvantage of this fastening system is that it is not very user-friendly to adjust the length of the system using pins.

It is therefore the object of the present invention to propose a fastening system for fastening a child seat and/or a base for a child seat to a motor vehicle seat, which fulfills the requirements described above with regard to stability, user-friendliness, safety and universal applicability in the most cost-effective and least error-prone manner possible.

This object is solved in particular by the features of claim 1.

In particular, the object is solved by a fastening system for fastening a child seat and/or a base for a child seat to a motor vehicle seat, comprising:
a hook which is suitable for engaging around a bracket provided on the vehicle side, in particular an Isofix anchorage (or an anchorage according to standard ISO 13216 or UN ECE R 145), in order to couple the fastening system to the motor vehicle seat, wherein the hook is switchable between a first position, in which it does not couple the fastening system to the motor vehicle seat (when the fastening system is in use), and a second position, in which it couples the fastening system to the motor vehicle seat (when the fastening system is in use),
and a preferably electrical detection device, comprising in particular a sensor which is suitable for detecting whether the hook is in the first or the second position (and thus also whether the child seat or the base for a child seat is in a state of use or in a state of non-use), wherein the detection device is configured for indirect detection of the respective position and/or wherein the detection device, in particular the sensor, has a distance relative to the hook, both in its first and in its second position.

A core idea of the invention is that the respective position is detected indirectly rather than directly. The position can therefore be detected in a particularly reliable and structurally simple manner. In particular, the path for transmitting information (for example in the direction of an evaluation unit and/or a display unit and/or signaling device) about the state determined in principle by a detection device is shortened. In contrast to the prior art, for example, no (electrical) cable or only a shorter cable is required to transmit the detected information about the state of use of the child seat or the base for a child seat along the (longitudinally displaceable) fastening system. This also results in a further advantage that the fastening system according to the present invention has a longer service life, for example if there is no additional or only a comparatively short (electrical) cable that could break, abrade etc. during the service life of the fastening system. Another advantage of the fastening system of the present invention may be that the absence or reduction of cables can improve or simplify longitudinal displacement compared to embodiments according to the prior art. In this context, it was also recognized in particular that in the prior art, as for example in EP 1 871 637 A1, a detector is arranged directly on the “second connector” (referred to as such in EP 1 871 637 A1). This results in particular in the problem that cables which are to conduct the detector information from the second connector to a display device or display unit which is spatially separated from the second connector can be damaged, e.g. crushed, broken and/or abraded.

Unless expressly stated otherwise, the terms “first”, “second” etc., e.g. second spring, are used to distinguish different elements from one another. The presence of a first spring or a second spring therefore does not imply that there must necessarily be more than one spring.

Preferably, the fastening system comprises a transfer device (preferably mechanical and/or rigid and/or having a maximum extension—understood as the distance between the pair of points of the transfer device with the greatest distance to one another—of at least 1 cm or at least 3 cm or at least 5 cm or at least 10 cm) which is movable, in particular with respect to the hook, and which, depending on the position of the hook, has at least two transfer device positions, in particular a first transfer device position or a second transfer device position, which is in contact with the hook in at least or exactly one position and, depending on the position of the hook, can assume at least two transfer device positions, in particular a first transfer device position, a second transfer device position and/or a third transfer device position, wherein the detection device is configured to detect the respective transfer device position, in particular directly. As a result, electrical transmission paths in particular can be reduced.

The fastening system can have a retaining latch which is switchable between a locking position, in which the retaining latch holds the hook in its second position, and a release position, in which the retaining latch does not hold the hook in its second position, wherein the retaining latch is preferably a component of the transfer device already mentioned above.

Preferably, the minimum distance between the detection device or sensor and the hook is at least 1 cm, preferably at least 3 cm, more preferably at least 5 cm or at least 10 cm.

The fastening system is preferably telescopic in design, wherein a first and a second section are provided, wherein the first and second section are displaceable relative to one another for adjusting a length of the fastening system (wherein this is to be understood in particular such that the first section and the second section are movable relative to one another, in particular translationally, preferably in the longitudinal direction), wherein an adjustment latch is preferably provided in or on the second section, which adjustment latch can be configured (or is adjustable) in such a way that the adjustment of the length of the fastening system is optionally possible and/or possible to a limited extent and/or not possible, wherein the first section is preferably fastened or fastenable to the child seat or the base for the child seat, optionally detachably, and/or is integrally formed at least in sections with the child seat or the base for the child seat, and/or wherein the second section is provided for fastening, optionally detachably, to the motor vehicle seat (wherein the motor vehicle seat has in particular a seat surface and a backrest).

Preferably, a second/the second section of the fastening system defines a cavity, for example formed by a tube section, wherein further preferably a/the transfer device is arranged predominantly or completely within the cavity. A/the retaining latch can also be arranged partially, in particular predominantly or completely, within the cavity.

Preferably, a/the second section of the fastening system has a proximal end and a distal end, wherein the hook is arranged at the distal end.

Preferably, the first section has a plurality of at least two, preferably at least 4 and/or at most 15, preferably at most 10 (e.g. 8 or 9 or 10), recesses spaced apart from one another in the longitudinal direction, each of which is suitable for receiving a blocking section (see below) of the adjustment latch. The distance between two recesses can be in the range of 1 cm-2 cm, e.g. 15 mm, and/or be at least 3% and/or at most 50% of a maximum extension, The recesses can be through-holes in particular,

In particular, the adjustment latch has a blocking section, in particular the blocking section already described above, which can be selectively brought into or out of engagement with a mating structure, in particular with at least one of the recesses of the first section, which are spaced apart from one another in the longitudinal direction, in order to adjust the second section with respect to the first section with regard to the length of the fastening system, wherein the blocking section can preferably assume at least one retracted position and/or wherein the blocking section can assume an extended position. In particular, the blocking section is wedge-shaped at least in sections.

Additionally or alternatively, the adjustment latch has in particular a first engaging section for holding the adjustment latch in the extended position. The first engaging section can be suitable for interacting with a latch blocking section of a transfer element (see further below) and for holding the adjustment latch in the extended position when the transfer element is in a second non-drive position (see further below).

Additionally or alternatively, the adjustment latch preferably has a second engaging section for holding the adjustment latch in the retracted position. The second engaging section can be suitable for interacting with a drive section of the transfer element (see further below) in such a way that the adjustment latch is driven into the retracted position when the transfer element is transferred into a drive position (see further below).

A free space can be provided adjacent to the first engaging section (in particular as a recess between the first engaging section and the second engaging section) in such a way that the latch blocking section of the transfer element is opposite the free space when the transfer element is in the drive position, so that the latch blocking section of the transfer element does not block switching of the retaining latch to the retracted position.

Additionally or alternatively, the adjustment latch preferably comprises a third engaging section, in particular as part of the locking section, which is adapted to be contacted by an edge of the mating structure, in particular the recess, of the first section when a force urges the first and second sections towards each other to reduce the length of the fastening system, wherein the third engaging section is preferably oblique with respect to the longitudinal direction so that the adjustment latch is urged towards the retracted position by the contacting of the third engaging section and the associated force.

The adjustment latch can be pretensioned towards the extended position, in particular by at least a third spring. The adjustment latch can also be rotatable about a second axis, which is preferably stationary relative to the second section, and can have a second axis section or a second bearing section for this purpose. The third spring (or at least a third of optionally several third springs) can be fastened to the second axis on the adjustment latch, in particular held and/or mounted, and/or can be designed as a leg spring.

Alternatively or additionally (in particular if several third springs are provided), the third spring (or at least a third of optionally several third springs) can also be fastened to the adjustment latch at a distance from the second axis, in particular held and/or mounted, and/or be designed as a tension spring. Other types of springs are also conceivable, in particular two third springs (redundant) can also be provided.

In the extended position of the adjustment latch, a side of the blocking section opposite the third engaging section can be arranged at least substantially perpendicular to the longitudinal direction (in particular forming an angle of 80° to 100° with the longitudinal direction). Alternatively or additionally, in the extended position of the adjustment latch, one side of the blocking section forming the third engaging section can form an angle in the range of 35° to 55°, preferably 45°, with the longitudinal direction.

Preferably, a transfer element (in particular the one already described above) is provided for the fastening system, preferably as a component of the above-mentioned transfer device, which is switchably arranged to be displaceable, in particular longitudinally displaceable, between at least a first non-drive position, a second non-drive position (in particular the one already described above) and a drive position (in particular the one already described above) in and/or on the second section, wherein the transfer element has a drive section (in particular the one already mentioned above) which is suitable for selectively cooperating with (a/the second) engaging section of the adjustment latch to transfer it from an/the extended position to a/the retracted position, The drive section can be formed by a surface that is at least substantially such that the longitudinal direction forms its surface normal.

Additionally or alternatively, the transfer element comprises a latch blocking section (in particular the one already mentioned above) suitable for selectively cooperating with (a/first) engaging section of the adjustment latch to prevent it from being transferred from an extended position to a retracted position. The latch blocking section may have a blocking surface which is straight in the longitudinal direction or inclined with respect thereto, at least by 5° and/or at most by 30°, preferably at most by 20°. If the latch blocking section is inclined, then preferably in such a way that a transfer of the transfer element from the second non-drive position (in which the latch blocking section blocks a transfer of the adjustment latch into the retracted position) into the first non-drive position (which is associated with the locking position of the retaining latch) is facilitated or is possible even if a force pushes the adjustment latch in the direction of the retracted position.

Additionally or alternatively, the transfer element is operatively connected to the retaining latch (in particular the one already mentioned above) in such a way that a movement of the transfer element, in particular by means of an actuating element, switches the retaining latch between the release position and/or the locking position.

Preferably, the adjustment latch and transfer element are matched to each other in such a way that a force for transferring the adjustment latch from the extended position to the retracted position can be transmitted to the latch blocking section by the first engaging section to a (not predominant) extent in terms of force in order to urge the transfer element from the second non-drive position to the first non-drive position.

Preferably, the adjustment latch is designed as a single piece, optionally monolithic.

The transfer element may be pretensioned, in particular by a second spring (see further below), towards the first non-drive position, in which the latch blocking section does not prevent the adjustment latch from being transferred from the extended position to the retracted position and in which the drive section does not cooperate with the adjustment latch to transfer it from the extended position to the retracted position. In the first non-drive position, the adjustment of the length of the fastening system may be permitted or enabled to a limited extent. The transfer element and the retaining latch can be designed and arranged such that the retaining latch is in the locking position when the transfer element is in the first non-drive position. In one embodiment, the transfer element comprises a second contact section for abutting against the first contact section of the retaining latch.

Additionally or alternatively, the transfer element is preferably operatively connected to the retaining latch in such a way that a movement of the transfer element, optionally by means of an actuating element (of the fastening system), can release the retaining latch for switching between the release position and/or the locking position. In particular, a movement of the transfer element by means of an actuating element can transfer the retaining latch from the locking position to the release position.

The transfer device can be made of plastic (at least 10% by weight or at least 30% by weight) and/or metal (at least 10% by weight or at least 30% by weight). Preferably, at least one section of the transfer device that comes into contact with the hook is made of metal, in particular steel (at least 50% by weight or at least 80% by weight) and/or a section of the transfer device that does not come into contact with the hook is made of plastic (at least 50% by weight or at least 80% by weight).

The transfer element can be made of plastic (at least 50% by weight or at least 80% by weight), in particular as an injection-molded part. The retaining bolt and transfer element can be firmly connected to one another, for example by fastening means, and/or a section of the retaining bolt, in particular the first contact section, can be extrusion-coated.

According to embodiments, the retaining latch (at least 50% by weight or at least 80% by weight) is made of metal, in particular steel, and/or the transfer element (at least 50% by weight or at least 80% by weight) is made of plastic, in particular so that, on the one hand, a high degree of stability is achieved in a relevant area and, on the other hand, weight and/or costs are saved.

In an alternative embodiment, the retaining latch and transfer element can be of monolithic design.

In general, the hook, the adjustment latch and/or the retaining latch (at least 50% by weight or at least 80% by weight) can be made of metal, in particular steel.

The transfer device, in particular the transfer element, can have a second guide between the second section and the transfer element, specifically, for example, by means of a clearance, optionally a guide groove or slot and a third projection, optionally a guide pin or bolt.

Preferably, the transfer device, in particular the transfer element, has support sections that rest directly on the second section in order to support the transfer device, in particular the transfer element, on the second section and, optionally, to enable the transfer element to slide along the second section. The support sections can in particular be designed as projections, wherein a support section can preferably be provided at the height of the latch blocking section opposite the blocking surface.

According to one embodiment, the fastening system can have in or on the second section, in particular in addition to the adjustment latch, a further adjustment latch, in particular a second adjustment latch, which can assume at least an extended position and a retracted position with respect to the first and second sections and is suitable for selectively permitting or restricting the adjustment of the length of the fastening system. At this point, reference should be made to EP 3 600 954B1, the disclosure of which is hereby to be included in the present application and in which, for example, two adjustment latches are provided for adjusting the length of the fastening system.

When preferably the hook is in its first position and the adjustment latch, in particular its second engaging section, is held in its retracted position by the transfer device, in particular by the interaction with the drive section of the transfer element, the transfer device is in particular in the third transfer device position.

When the hook is preferably in its first position and the adjustment latch, in particular its first engaging section, is prevented from being transferred from the extended to the retracted position by the transfer device, in particular by the interaction with the latch blocking section of the transfer element, the transfer device is in particular in the second transfer device position.

Preferably, when the hook is in its second position and the adjustment latch, in particular its blocking section, is in engagement with one of the recesses of the first section, the transfer device is in particular in the first transfer device position.

In particular, a/the transfer device, in particular a/the transfer element, may have a detection section which is suitable for being detected by the detection device, in particular the/a sensor, for determining the position of the transfer device, in particular the transfer element, wherein the detection section and the detection device, in particular the/a sensor, are preferably adjacent to each other in at least one transfer device position.

The motor vehicle seat can have (at least approximately) at least one, preferably exactly two, brackets in the transition area between the seat surface and the backrest, which can (in each case) be gripped by the hook of the fastening system. The child seat or the base for a child seat can have an underside which is intended to rest on the seat surface of the motor vehicle seat. The child seat or the base for a child seat can have a rear side which is intended to face the backrest of the motor vehicle seat and optionally rest against it.

Sections of the fastening system (in particular those already mentioned above) can be flush with the underside and/or the rear of the child seat or the base for a child seat.

In embodiments, the first and/or second section have (at least substantially) a square and/or rectangular cross-section, at least in sections.

The first and/or second section are preferably at least substantially profile-like (or as profile(s)), optionally hollow and/or tubular.

According to the embodiment, the first and/or second section have a maximum height (considered over a longitudinal extension) and/or a maximum diameter (considered over a longitudinal extension) of less than or equal to 5 cm, preferably 2 cm-3.5 cm.

According to the embodiment, the first and/or second section has/have a maximum width (considered over a longitudinal extension) of less than or equal to 3 cm, preferably 1.0 cm-2.0 cm,

Preferably, the first section can surround or enclose the second section in sections (or vice versa).

The first section is preferably at most 40 cm long and/or at least half as long as the second section and/or at least 2 cm, preferably at least 4 cm long.

The second section is preferably at least 4 cm long, further preferably at least 8 cm long and/or at most 40 cm long, preferably at most 30 cm long (e.g. 20 cm long)

In embodiments, the second section has a number of preferably inwardly directed projections. Each of the projections can be formed over an entire width (trans-verse to the longitudinal direction, in particular in the left-right direction) or over part of the width of the second section. Each of the projections can, for example, be formed as a bulge and/or designed as a bolt.

The second section preferably has a first projection for supporting the hook in its first position.

Alternatively or additionally, the second section preferably has a second projection, optionally several second projections, for guiding a latch and/or at least one third projection for guiding a/the transfer element. At least one optional fourth projection of the second section can serve to support the adjustment latch in its extended position.

The hook is preferably pretensioned towards its first position, in particular by a first spring. The hook can be rotatable about a first axis, which is preferably stationary relative to the second section. Furthermore, the hook can have a first axle section or a first bearing section. The hook can also have a locking section, which is suitable for engaging around the vehicle-side bracket, and/or be C-shaped or U-shaped.

In particular, the locking section can have two opposing legs, wherein one of the legs can be adjacent to an actuating section of the hook. The first spring can be fastened to the first axis on the hook, in particular held and/or mounted, and/or the first spring can be designed as a leg spring,

Alternatively, the first spring can be fastened to the hook at a distance from the first axis, in particular held and/or mounted, and/or the first spring can be designed as a tension spring. Other types of springs are also conceivable in principle.

A first (functional) end of the first spring can be supported on the hook. A second end of the first spring can be supported on the second section. The first and a second spring, in particular the second spring already described above, can also be identical and formed by a single (first/second) spring, which simultaneously pretensions the hook towards the first position and pretensions the retaining latch towards the locking position. This is preferably carried out by a first end of the first/second spring being supported on the hook and a second end of the first/second spring being supported on the retaining latch (or optionally on the transfer element).

Furthermore, a force acting on the actuating section in the longitudinal direction (e.g. as a result of pressing against the vehicle-side bracket), namely from the distal end of the second section towards the proximal end of the second section, can drive the hook to be transferred from the first position to the second position.

Preferably, the fastening system is completely retractable in the child seat or in the base for a child seat. The first section can be mounted on the child seat or the base for a child seat in such a way that it is completely retracted or is at least partially flush with the child seat or the base for a child seat. The second section, in turn, can be adjusted in at least one position relative to the first section so that it is also completely recessed or at least partially flush with the child seat or the base for a child seat.

The minimum length of the fastening system and the maximum length of the fastening system can differ by at least 4 cm, preferably at least 8 cm and/or at most 30 cm, preferably at most 20 cm.

A maximum projection of the fastening system over the child seat or the base of the child seat can be at least 4 cm, preferably at least 8 cm, and/or at most 30 cm, preferably at most 20 cm.

The retaining latch can be pretensioned towards the locking position, in particular by a second spring, in particular the second spring already described above, in particular a tension spring. A first end of the second spring can be supported on the retaining latch. A second end of the second spring can be supported on the second section. The hook and the retaining latch can be designed and arranged such that the hook holds the retaining latch in the release position by means of a hook blocking section when the hook is in its first position and that, furthermore, a transfer of the hook into its second position (for example by actuating the actuating section) allows a transfer of the retaining latch into its locking position, in particular driven by the second spring or the first/second spring.

The hook can have an engaging section into which the retaining latch engages with a locking section when the hook is in its second position and the retaining latch is in its locking position. The retaining latch can have a first contact section for contact with the transfer element. The retaining latch can also be L-shaped, in particular in such a way that the end of one arm of the L-shape forms the locking section and/or that the other arm of the L-shape (completely or in sections) forms the contact section. The retaining latch can be made of metal (at least 50% by weight or at least 80% by weight), in particular of steel. The retaining latch can be switchable in a translational manner (alternatively: rotationally or with translational and rotational part) between locking position and release position.

The transfer device, in particular the transfer element, is preferably operatively connected to an actuating element (of the fastening system), in particular the actuating element already described above, for actuation by a user.

Furthermore, the fastening system preferably has a first pin which is connected, in particular fixedly, to the second section and/or a second pin which is connected, in particular fixedly, to the transfer element, wherein the first and second pins are preferably provided for connection to an actuating element, in particular the actuating element already described above, wherein the first section preferably has a lateral guide slot which extends in the longitudinal direction, preferably over at least 50% of the length of the first section, wherein further preferably both the first pin and the second pin extend through this. The minimum and maximum length of the fastening system can be defined by the lateral guide slot.

Preferably, the second section has an elongated hole which overlaps with a section of the lateral guide slot of the first section and guides a movement of the second pin in the longitudinal direction towards or away from the first pin.

Preferably, an actuating element, in particular the actuating element already described above, is provided, in particular for, preferably (indirect or direct), manual actuation by the user. A fixed section of the actuating element is preferably connected to the second section via a first pin, in particular the first pin already described above, in particular fixedly, and a movable section of the actuating element is preferably operatively connected to the transfer element via a second pin, in particular the second pin already described above, and/or movable relative to the fixed section. Further preferably, the actuating element or the movable section thereof can be blocked by a holding device, wherein a release actuation can be provided in order to release the holding device. The actuating element, in particular its release actuation, can comprise at least one knob and/or at least one button and/or at least one slider and/or at least one operating lever.

Preferably, the movable section of the actuating element can be moved relative to the fixed section (and thus also to the second section), in particular against the force of a fourth spring.

The fastening system preferably has an installation position (see further below), wherein the transfer device is in the second transfer device position, the hook is in the first position, preferably the retaining latch is in the release position (held by the hook blocking section of the hook), further preferably the transfer element is in the second non-drive position, and the adjustment latch is in the extended position, wherein a/the release actuation (of the actuating element) is not actuated by the user.

In the event that, according to a preferred embodiment, the user, for example, starting from the installation position, wherein a/the release actuation (of the actuating element) is (still) not actuated, (firmly) presses the hook, in particular its actuating section, against the vehicle-side bracket, the transfer device is transferred from the second to the first transfer device position, in particular, the retaining latch is transferred to the locking position and, further preferably, the transfer element is transferred from the second to the first non-drive position, with the adjustment latch (still) being in the extended position, and the hook is transferred (by actuation of the actuating section by the vehicle-side bracket) to the second position, wherein the two legs of the hook engage around the vehicle-side bracket, so that the fastening system is transferred to a locking position (see below).

In the event that, according to a preferred embodiment, the user, for example, actuates, in particular increasingly presses, a/the release actuation (of the actuating element) starting from the locking position (now), the transfer device is transferred from the first to the second transfer device position, in particular the transfer element is (initially) transferred from the first (again) to the second non-drive position and further preferably the retaining latch is (again) held in the release position by the hook blocking section of the adjustment latch, wherein the adjustment latch is (now) (still) in the extended position and wherein the hook is brought into the first position (by the pretensioned first and/or first/second spring), so that the fastening system is (again) transferred to the installation position.

In the event that, according to a preferred embodiment, the user, for example, actuates, in particular increasingly presses, a/the release actuation (of the actuating element) starting from the installation position, the transfer device is transferred from the second to the third transfer device position, in particular the transfer element is transferred from the second non-drive position to the drive position and further preferably the retaining latch is (still) in the release position, and wherein the adjustment latch is driven to the retracted position, wherein the hook is (still) in the first position, so that the fastening system is transferred to an adjustment position (see further below).

In the event that, according to a preferred embodiment, the user, for example, no longer actuates a/the release actuation (of the actuating element) starting from the adjustment position, in particular releases the release actuation (slowly or abruptly), the fastening system is (re)transferred to the installation position.

In a further embodiment, the fixed section of an/the actuating element has a through-hole or slot on its outer side, in which, depending on the position of the movable section relative to the fixed section, color markings can be seen on the movable section to indicate the current position of the hook.

An actuating element may be provided (directly) on at least one of the first and second sections or remote from the first and second sections.

The detection device (of the fastening system), in particular the sensor, is preferably suitable for detecting the position of the transfer device, preferably of the/a retaining latch and/or of the/a transfer element, wherein the detection device can comprise a switch which is switchable between a first and a second switch position, wherein the switchover of the transfer device from the second to the first transfer device position, preferably the switchover of the retaining latch from the release position to the locking position and/or the switchover of the transfer element from the second non-drive position to the first non-drive position, can be linked to the switchover of the switch from the second switch position to the first switch position (accompanied by the transfer of the hook to the second position), and/or the switchover of the transfer device from the first to the second transfer device position, preferably the switchover of the retaining latch from the locking position to the release position and/or the switchover of the transfer element from the first non-drive position to the second non-drive position, can be linked to the switchover of the switch from the first switch position to the second switch position (accompanied by the transfer of the hook to the first position).

The switch of the detection device can be pretensioned in one of the two switch positions, preferably in the direction of the first switch position.

Preferably, a/the switch of the detection device comprises a button, in particular a push-button provided for pressing in or pressing down, wherein an extended position of the button is associated with a/the first switch position, and a pressed-down position of the button is associated with a/the second switch position (in which it can be at least further recessed or embedded in a switch housing than in the extended position), and/or a lever which, in a/the first switch position, is arranged in an inclined position with respect to the longitudinal direction of the fastening system and is suitable for switching the switch from the first switch position to a/the second switch position by the detection section of the transfer device, in particular of the transfer element, in order to transfer the button from the extended position to the depressed position, wherein the lever is thus moved into a position extending in the longitudinal direction and/or transversely to the longitudinal direction, wherein the lever is preferably movable back into the inclined position by a return spring, in particular a switch spring, in that the return spring, in particular the switch spring, transfers the button from the depressed position into the extended position (so that the button pushes the lever in the direction of the inclined position and the switch as a whole is pretensioned in the direction of the first switch position).

In this way, It can be ensured in particular by simple means that the switch (of the detection device) only detects a locking position of the retaining latch (and thus the second position of the hook) if this is actually present (because the transfer element must then be in the first non-drive position, so that the lever has not been set to the position extending in the longitudinal direction or transversely to the longitudinal direction and the push-button is not pressed in, while both in the second non-drive position and in the drive position of the transfer element, the switch is transferred to the second switch position).

Preferably, a/the detection section of the/a transfer device, in particular of a/the transfer element, and the detection device, in particular the sensor, are arranged between the adjustment latch and the proximal end of the second section (and/or, according to the embodiment, between the adjustment latch and the hook).

According to the embodiment, as seen from the hook, the detection device is located behind the adjustment latch.

Preferably, a/the detection section of a/the transfer device, in particular of a/the transfer element, has zones of different conductivity, wherein preferably at least one first zone is made of metal and/or one second zone is made of plastic.

Preferably, the detection device comprises electrical means, in particular an electrical sensor. It may be provided that the detection device is not connected to a mechanical display device (a mechanical signaling device) for displaying the position of the hook, and/or that the detection device is connected to an electrical display device (an electrical signaling device) for displaying the position of the hook. Electrical detection of the position of the hook has the advantage that the information determined in this way can be used flexibly, for example to control a (preferably electrical) display device (signaling device), and/or to permit or not permit other settings of the fastening system and/or the base for a child seat and/or the child seat. In particular, it is also very easy to implement a display device (a signaling device) whose display depends on the position of multiple, in particular two, hooks. A display device (a signaling device) can signal the position of the hook visually or acoustically, for example.

Preferably, the detection device of the fastening system, in particular the sensor, is designed as a conductivity sensor and/or a resistance measuring device, in particular in order to detect the zones of different conductivity of a/the detection section.

A change in the detection of the locking position of the retaining latch (optionally switching the switch (of the detection device) between the first switch position and the second switch position) can be associated with opening or closing an electrical circuit.

The detection device, in particular the sensor or the switch, can be connected to other components by an electrical connection, in particular by electrical cables.

Information as to whether or not the detection device detects the locking position of the retaining latch (optionally, whether the switch is in the first or second switch position) can be used to control other devices of the child seat or the base for a child seat. Examples are:
The child seat or the base for a child seat can comprise a (optionally optical or acoustic) signaling device which, depending on whether the retaining latch is detected by the detection device in the locking position, signals a fastening state of the child seat or the base for a child seat on the motor vehicle seat.
The child seat or the base for a child seat may alternatively or additionally comprise means, in particular active protection means, such as a bag that can be inflated with a gas or means for tightening a belt (e.g. a belt system of the child seat) or the like, the use of which is only permitted if the detection device detects that the retaining latch is in the locked position.

The fastening system (as a whole) can preferably be moved into the following positions:
an adjustment position, in particular that already described above, in which the hook is in the first position, the transfer device is in the third transfer device position, in particular the retaining latch is in the release position and the transfer element is in the drive position, wherein the adjustment latch is in the retracted position, the actuating element is actuated (in particular the user actuates the release actuation, in particular (permanently) presses and/or keeps pressed), and a/the switch of the detection device is in a/the second switch position, wherein the fastening system and thus the child seat or the base for a child seat is not fastened to the motor vehicle seat, so that the length of the fastening system is (freely) adjustable (between minimum and maximum length), and/or
a locking position, in particular that already described above, in which the hook is in the second position, the transfer device is in the first transfer device position, in particular the retaining latch is in the locking position and the transfer element is in the first non-drive position, wherein the adjustment latch is in the extended position, the actuating element is not actuated (in particular the user does not actuate the release actuation, in particular does not (increasingly) press and/or keep pressed) and a/the switch of the detection device is in a/the first switch position, so that the fastening system and thus the child seat or the base for a child seat is fastened to the motor vehicle seat, wherein the length of the fastening system is exclusively reducible (in particular when a force acts on the first section or on the child seat or the base for a child seat, respectively, which urges the first and second sections towards each other), and/or
an installation position, in particular that already described above, in which the hook is in the first position, the transfer device is in the second transfer device position, in particular the retaining latch is in the release position and the transfer element is in the second non-drive position, wherein the adjustment latch is in the extended position, the actuating element is not actuated (in particular the user does not actuate the release actuation, in particular does not (increasingly) press and/or keep it pressed) and a/the switch of the detection device is in a/the second switch position, wherein the fastening system and thus the child seat or the base for a child seat is not fastened to the motor vehicle seat, so that the length of the fastening system can be changed to a further limited extent or cannot be changed, and/or
an intermediate position when the fastening system is shortened from the locking position and the adjustment latch has not yet reached the next recess (of the first section) (wherein in particular hooks are in the second position, retaining latch in the locking position, transfer element in the first non-drive position and adjustment latch in the retracted position; the actuating element is not actuated (in particular the user preferably does not actuate the release actuation, in particular does not (increasingly) press and/or keep it pressed); and the fastening system and thus the child seat or the base for a child seat is fastened to the motor vehicle seat), wherein the length of the fastening system can be increased slightly (for example by at least 2 mm or at least 4 mmm and/or at most 2 cm or at most 1 cm), in particular until the adjustment latch engages in the previous recess (of the first section) when the first section and the second section are pulled apart.
As in the locking position, according to the embodiment, the intermediate position can allow the length of the fastening system to be reduced (in particular when a force acts on the first section or on the child seat or the base for a child seat, which forces the first and second sections towards each other). By allowing a slight movement in the other direction in the intermediate position, it can be easily achieved that the user can bring about at least one engagement with the previous recess, which in particular improves user-friendliness and safety.

Parts made of metal, in particular punched parts, comprising for example the hook and/or the adjustment latch and/or the retaining latch, can have different thicknesses and thereby have thin areas to enable the punching of smaller holes. The thin areas can be formed from the areas of normal thickness by applying high pressure (e.g. by a type of hammer blow).

The above-mentioned object is also solved in particular by a child seat or base for child seat, comprising at least one fastening system as described above, preferably at least or exactly two fastening systems—in particular arranged next to one another—as described above, in particular for fastening the child seat or the base for a child seat on a motor vehicle seat, in particular compatible with an Isofix anchorage or an anchorage according to standard ISO 13216 or UN ECE R 145.

Furthermore, the above-mentioned object is solved by a method for detecting a position of the hook of the fastening system and/or the child seat or the base, as described above, wherein the detection device, comprising in particular a sensor, detects whether the hook is in the first or the second position, wherein the detection device is configured for indirect detection of the respective position and/or wherein the detection device, in particular the sensor, has a distance relative to the hook, in particular both in its first and in its second position.

Further embodiments are shown in the subclaims.

In the following, the invention is described with reference to exemplary embodiments, which are explained in more detail with reference to the illustrations, wherein:

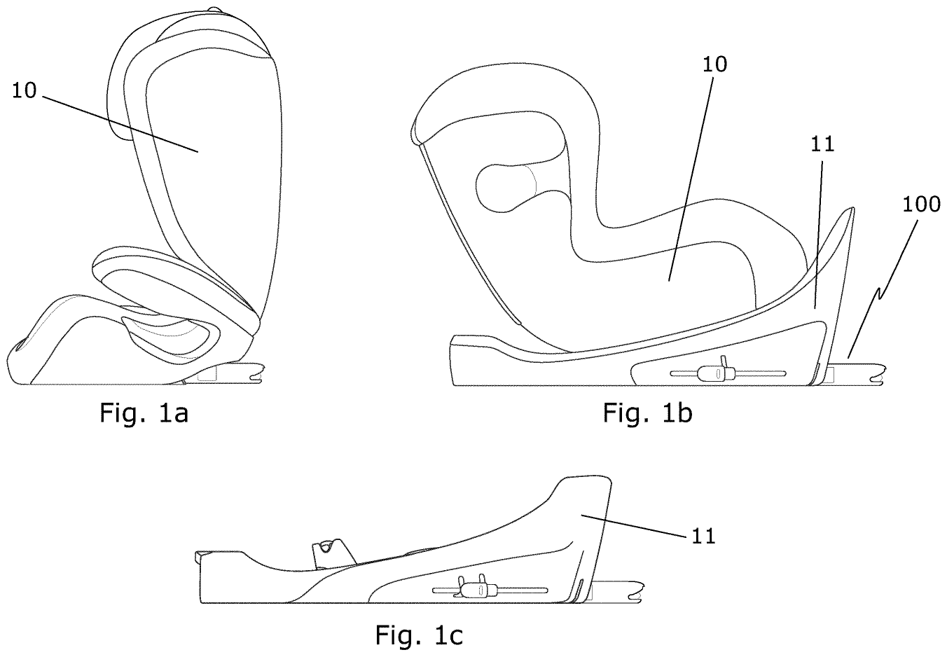

FIG. 1a shows a child seat with a fastening system according to the invention;

FIG. 1b shows the child seat according to FIG. 1a on a base for a child seat with the fastening system;

FIG. 1c shows the base for a child seat with the fastening system;

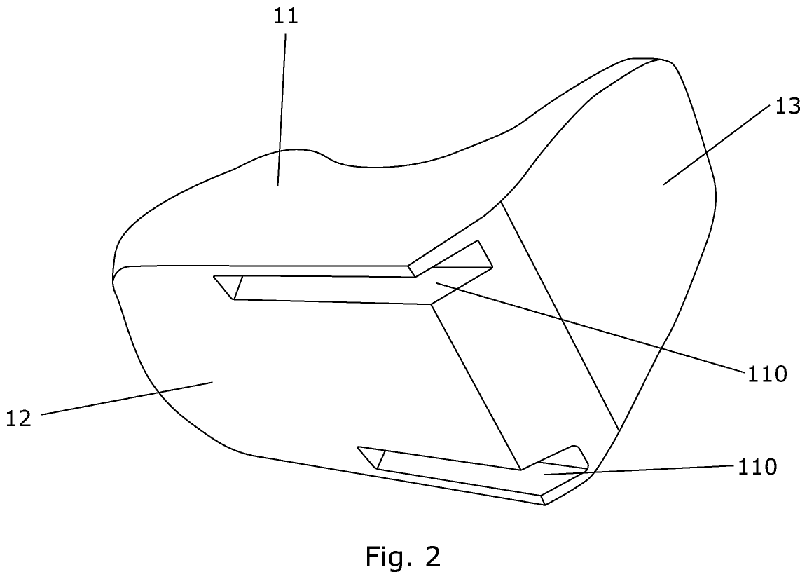

FIG. 2 shows the base for a child seat with an underside for support on a seat surface of a motor vehicle seat;

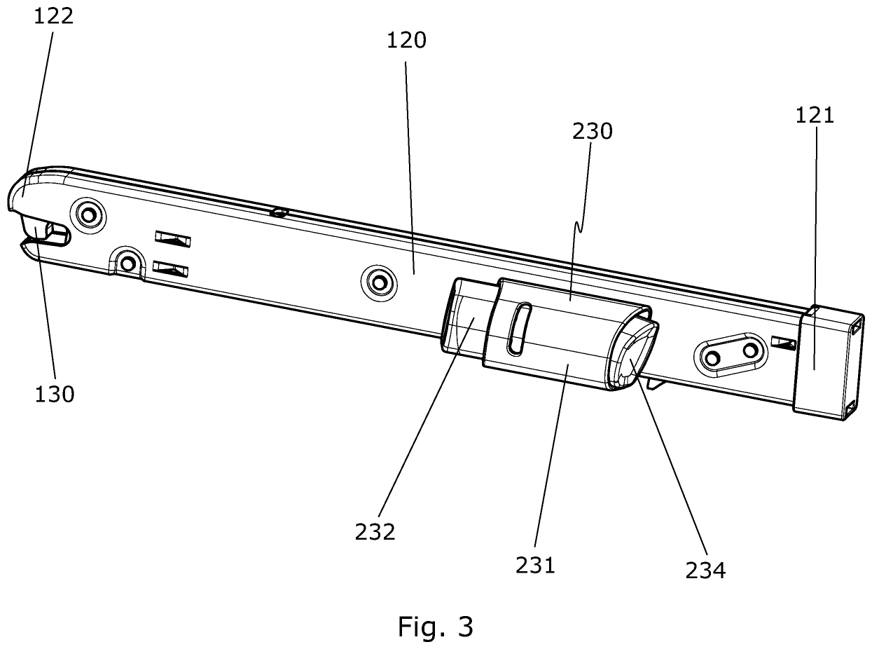

FIG. 3 shows a second section of the fastening system according to the invention with an actuating element arranged laterally on the second section with a non-actuated release actuation;

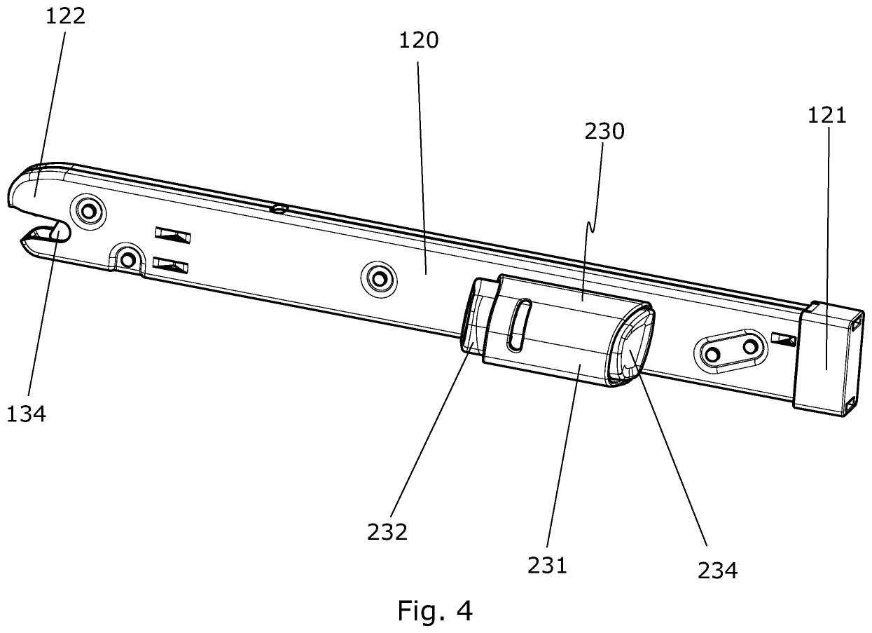

FIG. 4 shows a representation analogous to FIG. 3 with actuated release actuation;

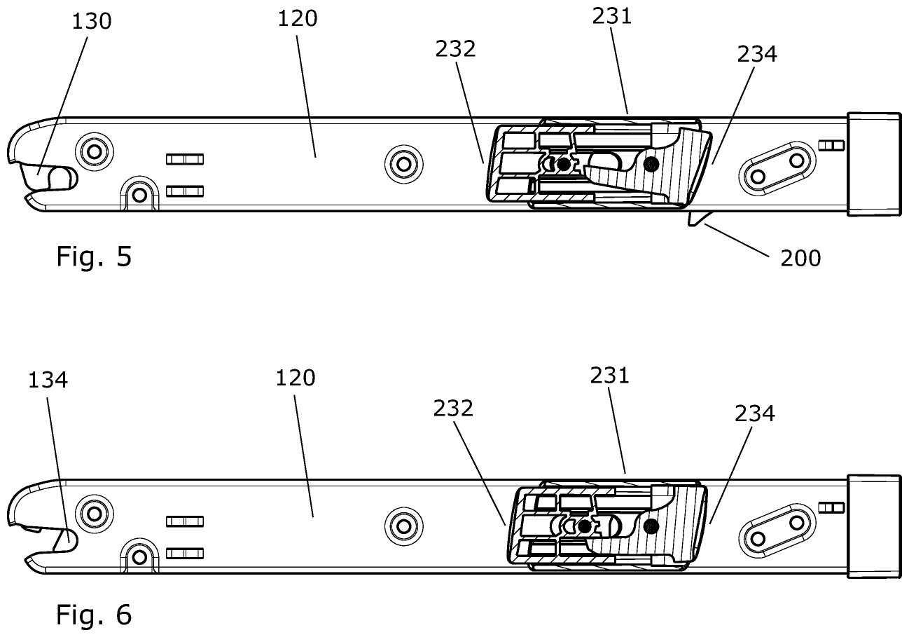

FIG. 5 shows an illustration corresponding to FIG. 3, but now the in-ternal structure of the non-actuated actuating element can be seen;

FIG. 6 shows an illustration corresponding to FIG. 4, but now the in-ternal structure of the actuated operating element can be seen;

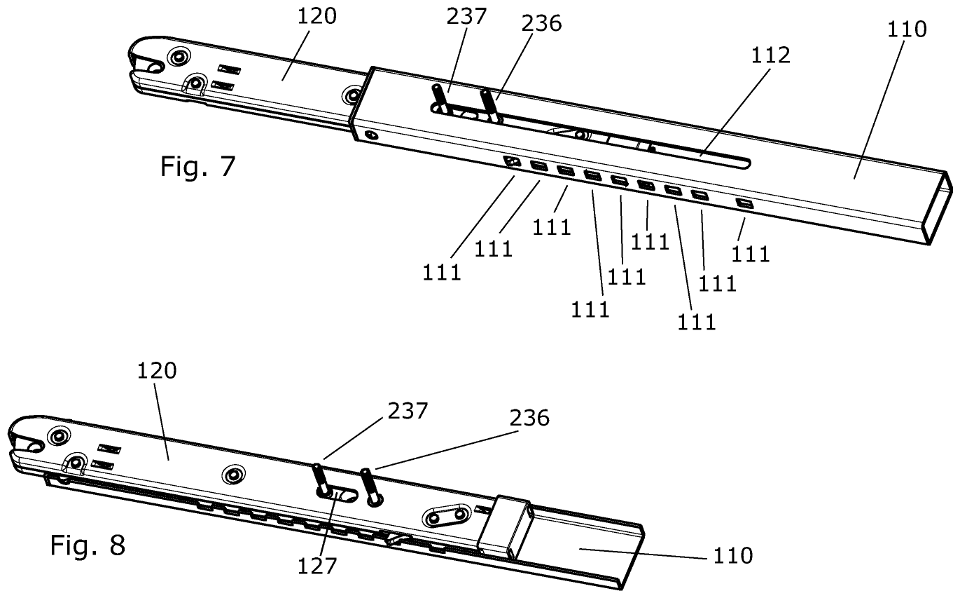

FIG. 7 shows the fastening system with a first section and the second section;

FIG. 8 shows the fastening system with only one half of the first section;

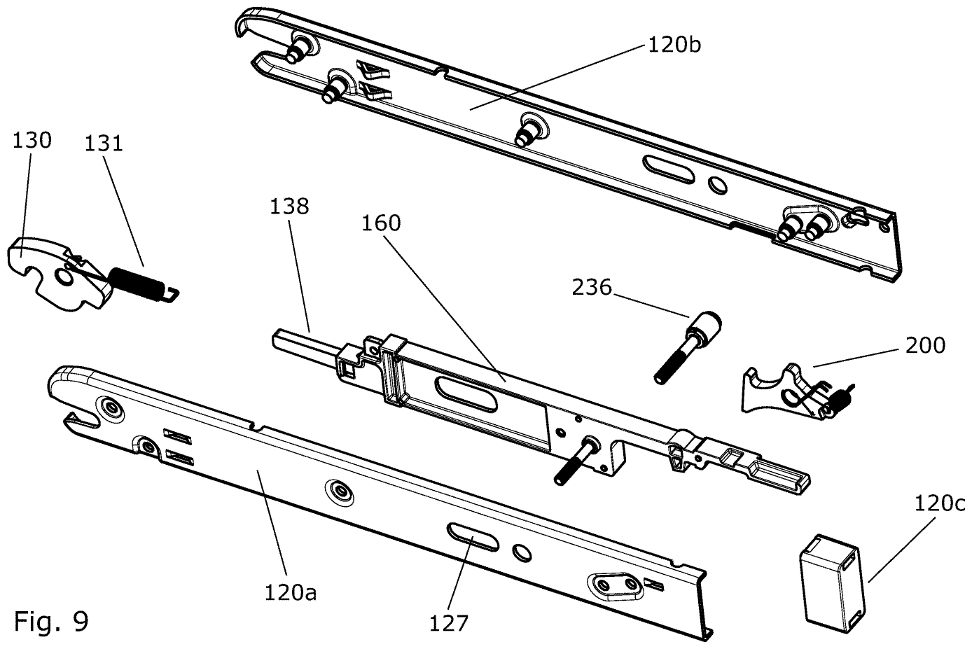

FIG. 9 shows an exploded view of the second section of the fastening system;

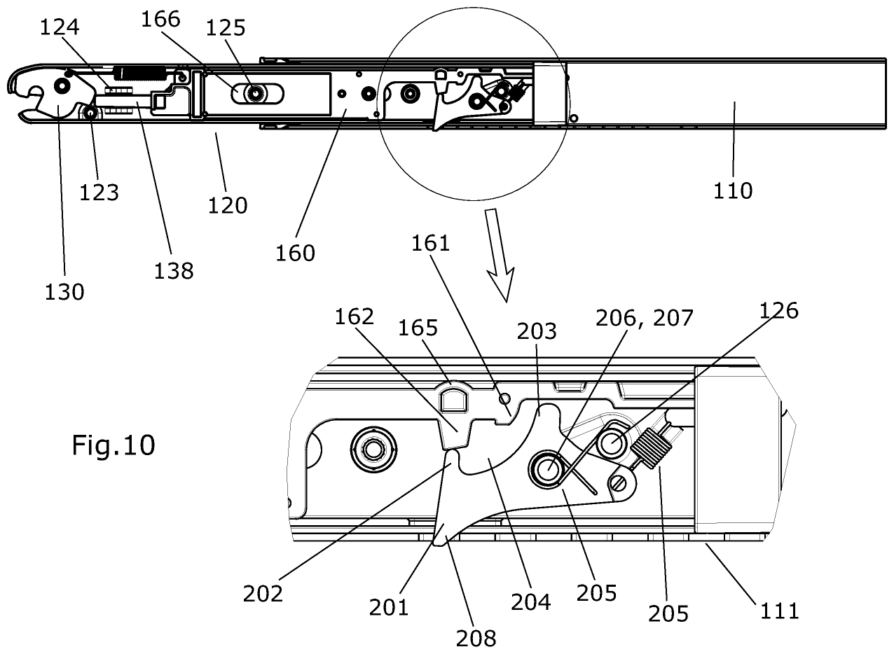

FIG. 10 shows an illustration of the entire fastening system with an enlarged view of an adjustment bolt and various sections of a transfer element;

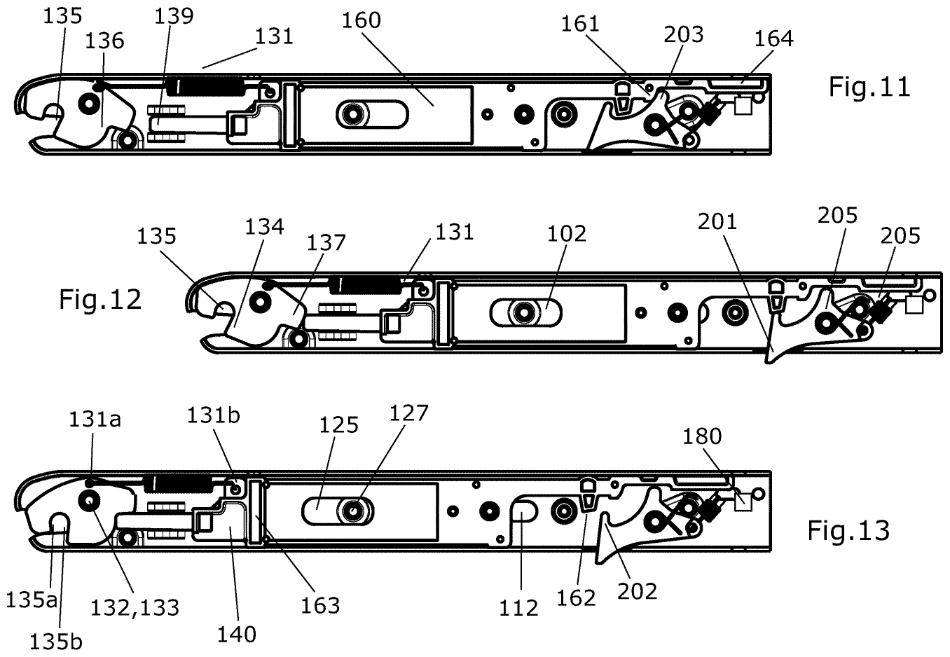

FIG. 11 shows one half of the second section of the fastening system with adjustment latch in an adjustment position;

FIG. 12 shows one half of the second section of the fastening system with adjustment latch in an installation position;

FIG. 13 shows one half of the second section of the fastening system with adjustment latch in a locked position;

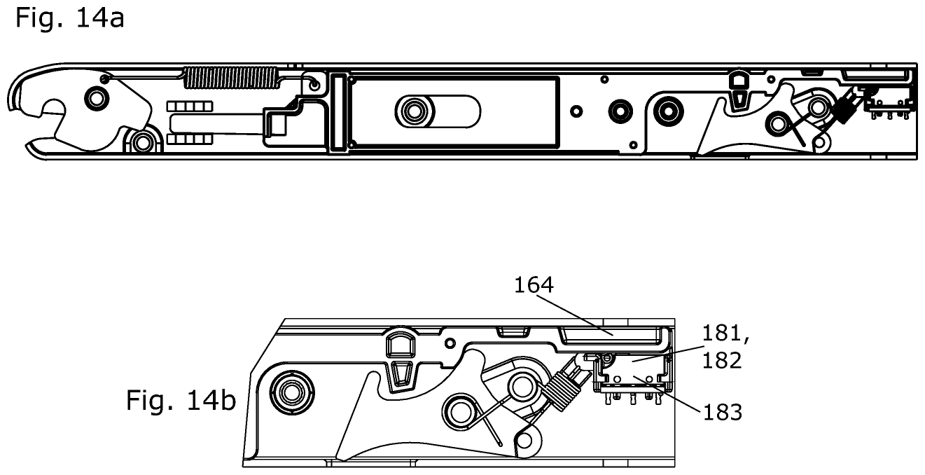

FIG. 14a shows one half of the second section of the fastening system with adjustment latch in the adjustment position according to FIG. 11, wherein the detection device specifically comprises a sensor designed as a switch;

FIG. 14b shows an enlargement of the switch of the detection device according to FIG. 14a, which is in a second switch position;

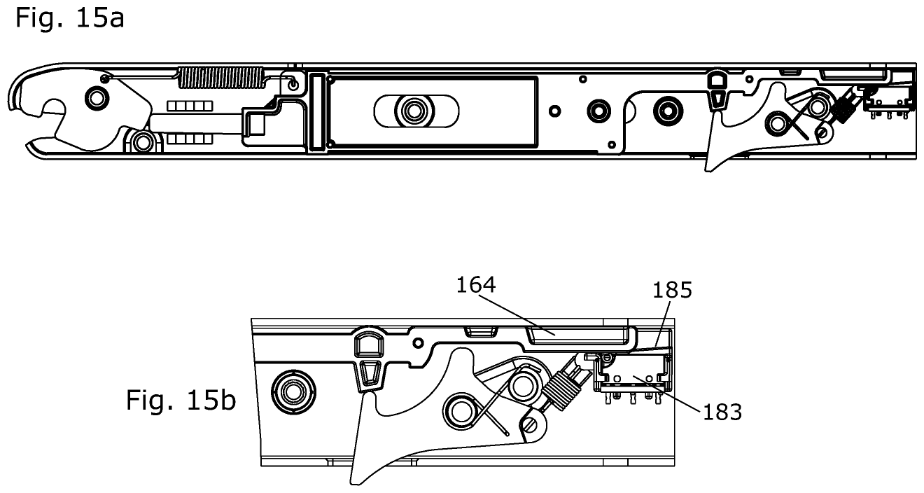

FIG. 15a shows one half of the second section of the fastening system with adjustment latch in the installation position according to FIG. 12, wherein the detection device specifically comprises a sensor designed as a switch;

FIG. 15b shows an enlargement of the switch of the detection device according to FIG. 15a, wherein the switch is in the second switch position;

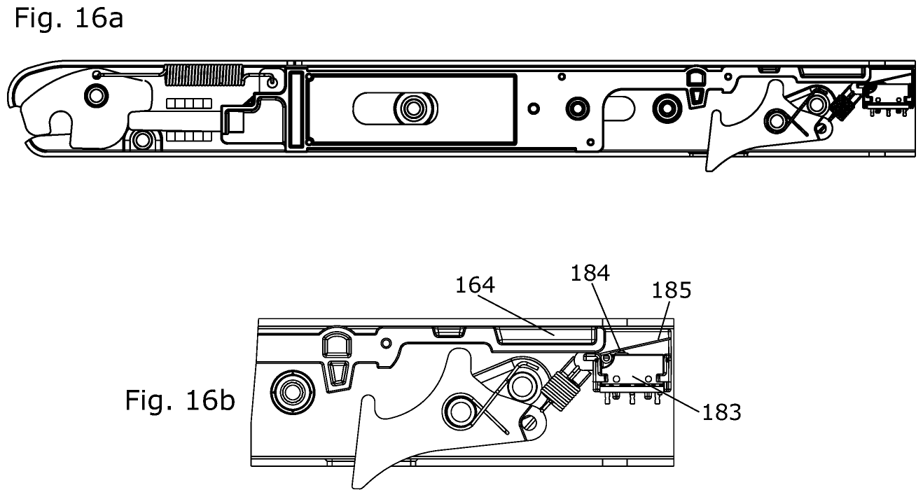

FIG. 16a shows one half of the second section of the fastening system with adjustment latch in the locking position according to FIG. 13, wherein the detection device specifically comprises a sensor designed as a switch;

FIG. 16b shows an enlargement of the switch of the detection device according to FIG. 16a, wherein the switch is in a first switch position;

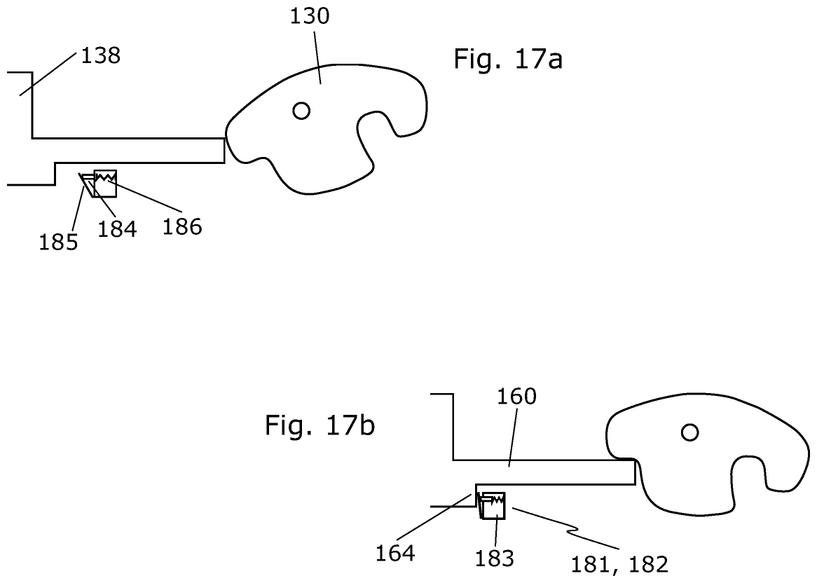

FIG. 17a shows a schematic interaction of parts of the fastening system, wherein the switch of the detection device is in the first switch position;

FIG. 17b shows a schematic interaction of parts of the fastening system, wherein the switch of the detection device is in the second switch position;

In the following description of the figures, the same reference numbers are used for identical and identically acting parts.

FIG. 1a shows a child seat 10 with a fastening system 100 according to the invention.

FIG. 1b shows the child seat 10 on a base for a child seat 11 with the fastening system 100.

FIG. 1c shows the base for a child seat 11 with the fastening system 100.

FIG. 2 shows the base for a child seat 11 with an underside 12 for resting on a seat surface of a motor vehicle seat, and with a rear side 13 which is intended to face in the direction of a backrest of the motor vehicle seat. Integrally formed with the base for the child seat 11, two first sections 110 of the fastening system according to the invention are shown schematically. The two first sections 110 are flush at the bottom with the underside 12 of the base for the child seat 11. They also do not protrude rearwardly beyond the rear side 13.

FIG. 3 shows a second section 120 of the fastening system with a proximal end 121 formed as an end cap and a distal end 122. Also shown to the side of the second section 120 is an actuating element 230 with a fixed section 231 and a movable section 232 as well as a release actuation 234. The fixed section 231 has a through-hole (without reference number) on its outer side, in which, depending on the position of the movable section 232 relative to the fixed section 231, color markings not shown on the movable section 232 can be seen in order to indicate the momentary position of the hook 130 shown here in its second position. The release actuation 234 is not actuated, and the movable section 232 is in an initial position. The hook 130 is located at the distal end 122 of the second section 120 and can be switched between a first position and a second position, as already shown in FIG. 3. In the second position, it includes a notch (without reference number) at the distal end 122 of the second section 120.

In FIG. 4, the same elements are shown as in FIG. 3, but in contrast to this, the release actuation 234 is actuated and the movable section 232 is in a depressed position. The hook 130 is in its first position, so that an actuating section 134 of the hook can be seen.

FIG. 5 corresponds to FIG. 3 and FIG. 6 corresponds to FIG. 4. However, the internal structure of the actuating element 230 can now be seen in each case: It can be seen that the release actuation 234 is mounted rotatably about an axis (without reference number). Its actuation against the force of a spring, which is not shown, pivots an end formed as a holding device downwards and allows the movable section 232 to be pressed in towards the proximal end 121. The movable section 232 is also pressed in against the force of a spring, which is also not shown, and results in the hook 130 being transferred to the first position, as explained in detail later.

FIG. 7 shows the fastening system 100 according to the invention with the first section 110 and the second section 120. The first section 110 has a plurality of recesses 111, shown here as through-holes, on its underside. On the side facing the actuating element 230, which is not shown here, the first section 110 also has a lateral guide slot 112. A first pin 236 and a second pin 237, which are provided for connection to the actuating element 230, extend through this. The fastening system 100 is in a maximum extension.

FIG. 8 shows the fastening system 100, wherein only one half of the first section 110 is shown here for reasons of understanding. The fastening system 100 is shown here retracted relatively far back and it can be seen that the first pin 236 is firmly connected to the second section 120. In addition, it can now be seen that the second section has an elongated hole 127 through which the second pin 237 extends.

The exploded view in FIG. 9 shows that the second section 120 comprises a first half 120a and a second half 120b as well as an end cap 120c. Furthermore, the hook 130 together with a first/second spring 131, a transfer element 160 together with a retaining latch 138, the first pin 236, an adjustment latch 200 and the elongated hole 127 can be seen.

FIG. 10 again shows a representation of the entire fastening system 100 according to the invention with the first section 110 and the second section 120. It can be seen that the hook 130 is supported on a first projection 123 of the second section in the first position shown. The retaining latch 138 is in a release position and is connected to the transfer element 160. A third projection 125 connects the two halves 120a and 120b of the second section 120 and provides more stability to the second section 120. The third projection 125 of the second section 120 increases the mechanical stability of the second section and, together with a clearance 166 of the transfer element 160, can also form a second guide 102 as a side effect.

In the enlarged view of the adjustment latch 200 and sections of the transfer element 160 shown below, further details can be seen: the adjustment latch 200 has a blocking section 201 that is wedge-shaped. As shown, a first engaging section 202 can cooperate with a latch blocking section 162 to prevent the transfer of the adjustment latch 200 from an extended position shown, in which the blocking section 201 is in engagement with one of the recesses 111 of the first section 110, to a retracted position. Opposite the latch blocking section 162, the transfer element 160 has a support section 165 with which it can be supported on the second section 120.

A second engaging section 203 of the adjustment latch 200 is located opposite a drive section 161 of the transfer element 160 and is intended to interact with the latter in order to transfer the adjustment latch 200 from the extended position to the retracted position, In the illustrated position of the transfer element 160, however, the drive section 161 and the second engaging section 203 are spaced apart from one another.

Between the first engaging section 202 and the second engaging section 203 is a free space 204, in which the latch blocking section 162 is located when the transfer element 160 is in a drive position. On the side of the blocking section 201 facing the proximal end 121 there is a third engaging section 208, which is intended to cooperate with an edge of the recess 111 with which the adjustment latch 200 is engaged in order to urge the adjustment latch 200 in the direction of the retracted position.

The adjustment latch 200 is pivotably movable about a second axis 206, on which it is mounted with a second bearing section 207. Two third springs 205, one of which is a leg spring and the other of which is a tension spring, tension the adjustment latch 200 in the direction of the extended position. The third spring 205, which is designed as a leg spring, is supported with one end on the first latch 200 and with the other end on a fourth projection 126 of the second section 120.

The third spring 205, which is designed as a tension spring, is supported with one end on the adjustment latch 200 and with the other end on the second section 120. It can be seen that the support point of the third spring 205, which is designed as a tension spring, is thinner than the rest of the adjustment latch 200. In the extended position shown, the adjustment latch 200 is supported on the fourth projection 126.

FIG. 11 again shows the second section 120 of the fastening system 100 according to the invention. A hook 130 with a locking section 135 is arranged at the distal end 122, wherein the hook 130 is mounted with a first bearing section 133 rotatably about a first axis 132. A first/second spring 131 is fastened with a first end 131a to the hook 130, specifically approximately above the first bearing section 133, and is fastened with a second end 131b to an arm of the L-shaped retaining latch 138.

The retaining latch 138 is movable together with the transfer element 160, which has, among other things, a drive section 161 and a detection section 164, In the illustrated adjustment position of the fastening system 100 according to the invention, the hook 130 is in its first position (open), the retaining latch 138 is in its release position and the transfer element 160 is in the drive position, the adjustment latch 200 is in the retracted position and the actuating element 230 (not illustrated) is actuated. The child seat 10 connected to the fastening system 100 or the base for a child seat 11 connected to the fastening system 100 are thus not fastened to the motor vehicle seat 1, and the length of the fastening system 100 can be freely adjusted between a minimum extension and a maximum extension. A detection device 180 is shown schematically (see also FIG. 13).

FIG. 12 shows the same elements as FIG. 11, but the fastening system 100 according to the invention is now in an installation position. Furthermore, the hook 130 is in the first position (open) and the retaining latch 138 is in the release position. However, the transfer element 160 is now in a second non-drive position and the adjustment latch 200 is in the extended position. The actuating element 230 (not shown) is not actuated. The fastening system 100 is not fastened to the motor vehicle seat 1 and the length of the fastening system 100 cannot be changed, because the latch blocking section 162 of the transfer element 160 blocks the adjustment latch 200 at the first engaging section 201 and holds it in the extended position.

FIG. 13 shows the elements already shown in FIGS. 11 and 12, but the fastening system 100 according to the invention is now in a locking position. Now the hook 130 is in the second position, the retaining latch 138 is in a locking position and the transfer element 160 is in a first non-driven position. The adjustment latch 200 is in the extended position, and the actuating element 230 (not shown) is not actuated. The fastening system 100 and, optionally, the child seat 10 or the base for a child seat 11 connected thereto are fastened to the motor vehicle seat 1 and the length of the fastening system 100 cannot be increased, but can only be reduced if a force acts on the first section 110 or on the child seat 10 or the base for a child seat 11, respectively, which urges the first section 110 and the second section 120 towards each other. It can be seen that the detection device 180 is now no longer opposite the detection section 164, so that a distinction can be made between the locking position and the release position of the retaining latch 138 (and thus between the first and second position of the hook 130).

FIG. 14a and the associated magnification according to FIG. 14b essentially correspond to FIG. 11, wherein the fastening system is in the adjustment position and wherein the detection device specifically comprises a sensor 181 in the form of a switch 182, which can be better recognized in the magnification. The switch 182 has a housing 183 and is located in the second switch position. The lever 185 is aligned at least essentially in the longitudinal direction and is therefore not easily recognizable.

FIG. 15a and the corresponding magnification FIG. 15b essentially correspond to FIG. 12, wherein the fastening system is in the installation position. FIGS. 15a and 15b again show, as in FIGS. 14a and 14b, the specific sensor 181 in the form of switch 182. It can be seen that the detection section is still pressing down the lever 185 of switch 182, so that the push-button 184 (which is still not visible) is recessed in the housing and the switch is (still) in the second switch position.

FIG. 16a and the associated magnification according to FIG. 16b essentially correspond to FIG. 13, wherein the fastening system is in the locked position. FIGS. 16a and 16b again show the sensor 181, which is preferably designed as a switch 182, as already shown in FIGS. 14a to 15b. Now the detection section 164 has been shifted so far in the direction of the distal end 122 of the second section 120 that the switch spring (not shown) has pushed the now recognizable push-button 184 into the extended position, wherein the lever 185 has been transferred into the inclined position. The switch of the sensor 181 is thus in the first switch position.

FIGS. 17a and 17b again show very schematically a basic possibility of the interaction of parts of the fastening system 100, specifically the second section 120, in particular the hook 130, the transfer element 160 (in particular the retaining latch 138) and the sensor 181 (in particular the push-button 184, the lever 185 and the return spring 186). FIG. 17a shows the switch 182 in the first switch position and at a distance from the detection section 164, specifically with push-button 184 in the extended position, lever 185 in the inclined position and relaxed switch spring 186 (here exemplarily designed as a compression spring), FIG. 17b shows the switch 182 in the second switch position, specifically with lever 185 pushed into a straight position (here: transverse to the longitudinal direction) by the detection section 164, which presses down the push-button 184 against the force of the switch spring 186.

For technical reasons, the springs are not always shown correctly in some figures.

At this point, it should be noted that all the parts described above are claimed to be essential to the invention when viewed individually and in any combination, in particular the details shown in the drawings. Modifications thereof are familiar to the person skilled in the art.

Furthermore, it should be noted that the aim is to achieve the broadest possible scope of protection. In this respect, the disclosure contained in the claims can also be specified by features that are described with further features (even without these further features necessarily being included). It is explicitly pointed out that round brackets and the term “in particular” are intended to emphasize the optionality of features in the respective context (which does not mean, conversely, that a feature is to be regarded as mandatory in the corresponding context without such identification). The term “element/-element” is preferably intended to indicate a respective coherent structure, which in turn can be connected to at least one other structure (to form a possibly one-piece and/or non-movable overall structure) or can be delimited from all other structures.

### LIST OF REFERENCE SIGNS

1 Car seat
2 Vehicle seat backrest
3 Vehicle seat surface
4 Bracket
10 Child seat
11 Base for a child seat
12 Underside
13 Rear side
100 Fastening system
101 First tour
102 Second guide
110 First section
111 Recess
112 (Lateral) guide slot
120 Second section
120a, 120b First and second half
120c End cap
121 Proximal end
122 Distal end
123 First projection
124 Second projection
125 Third projection
126 Fourth projection
127 Elongated hole
130 Hook
131 First/second spring
131a, 131b First and second end of the first/second spring
132 First axis
133 First bearing section
134 Actuating section
135 Locking section
135a, 135b Legs
136 Engagement section
137 Hook blocking section
138 Retaining latch
139 Locking section
140 First contact section of the retaining latch
160 Transfer element
161 Drive section
162 Latch blocking section
163 Second contact section of the transfer element
164 Detection section
165 Support section
166 Clearance
180 Detection device
181 Sensor
182 Switch
183 Housing
184 Button (push-button)
185 Lever
186 Return spring (switch spring)
200 Adjustment latch
201 Blocking section
202 First engaging section
203 Second engaging section
204 Free space
205 Third spring
206 Second axis
207 Second bearing section
208 Third engaging section
230 Actuating element
231 Fixed section
232 Movable section
233 Holding device
234 Release actuation
235 Fourth spring
236 First pin
237 Second pin

1. A fastening system for fastening a child seat or a base for the child seat to a motor vehicle seat, comprising:
a hook which is suitable for engaging around a bracket provided on a motor vehicle, in particular an Isofix anchorage, in order to couple the fastening system to the motor vehicle seat,
wherein the hook is switchable between a first position, in which it does not couple the fastening system to the motor vehicle seat, and a second position, in which it couples the fastening system to the motor vehicle seat, and an electrical detection device, comprising in particular a sensor which is suitable for detecting whether the hook is in the first position or the second position,
wherein the detection device is configured for indirect detection of the first position and the second position or wherein the detection device, in particular the sensor, has a distance relative to the hook, both in the first position and in the second position.

2. The fastening system according to claim 1 wherein
a transfer device, in particular movable, preferably rigid, relative to the hook, which is in contact with the hook in at least or exactly one position and, depending on a position of the hook, can assume at least two transfer device positions, in particular a first transfer device position, a second transfer device position or a third transfer device position,
wherein the detection device is configured to detect the first transfer device position, the second transfer device position, or the third transfer device position, in particular directly.

3. The fastening system according to claim 2 wherein
a retaining latch which is switchable between a locking position, in which the retaining latch holds the hook in its second position, and a release position, in which the retaining latch does not hold the hook in its second position,
wherein the retaining latch is a component of the transfer device.

4. The fastening system according to claim 1,
wherein a minimum distance between the detection device or the sensor and the hook is at least 10 cm.

5. The fastening system according to claim 3,
wherein the fastening system is telescopic in design,
wherein a first section and a second section are provided,
wherein the first section and the second section are displaceable relative to one another for adjusting a length of the fastening system,
wherein an adjustment latch is provided in or on the second section, which adjustment latch can be configured with respect to the first section and the second section such that adjustment of the length of the fastening system is possible to a limited extent or not possible,
wherein the first section is fastened or fastenable to the child seat or the base for the child seat, optionally detachably, or is integrally formed at least in sections with the child seat or the base for the child seat, or wherein the second section is provided for fastening, optionally detachably, to the motor vehicle seat or
wherein a transfer element is provided as a component of the transfer device, which is arranged to be displaceable, in particular longitudinally displaceable, between at least a first non-drive position, a second non-drive position and a drive position in or on the second section,
wherein the transfer element has a drive section which is suitable for selectively cooperating with an, in particular second, engaging section of the adjustment latch in order to transfer the latter from an extended position into a retracted position, or
a latch blocking section suitable for selectively cooperating with a, in particular first, engaging section of the adjustment latch to prevent the latter from being transferred from an extended position to a retracted position, or
which is operatively connected to the retaining latch, such that a movement of the transfer element switches the retaining latch between the release position or the locking position.

6. The fastening system according to claim 1,
wherein a second section of the fastening system comprises a proximal end and a distal end, wherein the hook is arranged at the distal end.

7. The fastening system according to claim 5,
wherein
transfer element has a detection section which is suitable for being detected by the detection device, in particular the/a sensor, for determining the position of the transfer device, in particular the transfer element, wherein the detection section and the detection device, in particular the/a sensor, are preferably adjacent to one another.

8. The fastening system according to claim 7
wherein the detection device, in particular the sensor, is suitable for detecting the position of the transfer device, or the retaining latch or the transfer element,
wherein the detection device comprises a switch which is switchable between a first and a second switch position, wherein a switchover of the transfer device from the second to a first transfer device position,
wherein the switchover of the retaining latch from the release position to the locking position or the switchover of the transfer element from the second non-drive position to the first non-drive position is linked to the switchover of the switch from the second switch position to the first switch position, and/or or
wherein the switchover of the transfer device from the first to the second transfer device position, preferably the switchover of the retaining latch from the locking position to the release position or the switchover of the transfer element from the first non-drive position to the second non-drive position, is linked to the switchover of the switch from the first switch position to the second switch position.

9. The fastening system according to claim 7,
wherein a switch of the detection device comprises a button, in particular a push-button provided for pressing in or pressing down,
wherein an extended position of the button is associated with a first switch position, and a pressed-down position of the button is associated with a second switch position, or
comprises a lever which, in the first switch position, is arranged in an inclined position with respect to a longitudinal direction of the fastening system and is suitable for switching the switch from the first switch position to a second switch position from the detection section of the transfer device, in particular of the transfer element, in order to transfer the button from the extended position to the pressed-down position,
wherein the lever is thus moved into a position extending in the longitudinal direction or transversely to the longitudinal direction,
wherein the lever is movable back into the inclined position by a return spring, in particular a switch spring, in that the return spring, in particular the switch spring, transfers the button from the pressed-down position into the extended position.

10. The fastening system according to claim 9,
wherein the detection section of the transfer device, in particular of transfer element, and the detection device, in particular the sensor, are arranged between the adjustment latch and a proximal end of the second section.

11. The fastening system according to claim 9,
wherein the detection section of the transfer device, in particular the transfer element, has zones of different conductivity,
wherein at least a first zone is made of metal and/or or a second zone is made of plastic.

12. The fastening system according to claim 11,
wherein the detection device of the fastening system, in particular the sensor, is designed as a conductivity sensor or a resistance measuring device, in order to detect the zones of different conductivity of the detection section.

13. A child seat or base for a child seat, comprising at least two fastening systems according to claim 1, arranged next to one another, for fastening the child seat or the base for the child seat on a motor vehicle seat, compatible with an Isofix anchorage or an anchorage according to standard ISO 13216 or UN ECE R 145.

14. A method for detecting a position of the hook of the fastening system according to claim 1, wherein the detection device, comprises a sensor, detects whether the hook is in the first or the second position, wherein the detection device is configured for indirect detection of the respective position or wherein the detection device, in particular the sensor, has a distance relative to the hook, both in its first and in its second position.
